(19) United States
(12) Patent Application Publication
(10) Pub. No.: US 2015/0324742 A1
(43) Pub. Date: Nov. 12, 2015

(54) LOCATION TRACKING IN A DISTRIBUTION NETWORK

(71) Applicant: Controlant ehf., Reykjavik (IS)

(72) Inventors: Gísli Herjólfsson, Kópavogur (IS); Erlingur Brynjúlfsson, Reykjavik (IS); Árni Brynjúlfsson, Reykjavik (IS); Ólafur Gudmundsson, Reykjavik (IS); Atli Thor Hannesson, Kópavogur (IS)

(73) Assignee: Controlant ehf., Reykjavik (IS)

(21) Appl. No.: 14/412,612

(22) PCT Filed: Jul. 4, 2013
(86) PCT No.: PCT/IS2013/050007

§ 371 Date: Jan. 2, 2015

(30) Foreign Application Priority Data
Jul. 4, 2012 (IS) 050035
Mar. 1, 2013 (IS) 050046

(51) Int. Cl. G06Q 10/08

(52) U.S. Cl. CPC G06Q 10/0833; G06Q 10/087

(57) ABSTRACT

The present invention relates to a fully automatic method and a system for distribution monitoring of shipments and automatic location assignment of objects with virtual location information and wireless technology.

### BACKGROUND OF THE INVENTION

The present invention relates to a fully automatic method and a system for distribution monitoring of shipments and automatic location assignment of objects with virtual location information and wireless technology using minimum infrastructure.

### BACKGROUND OF THE INVENTION

Knowing the whereabouts of an object in a distribution network is important for many reasons. A supplier distributing dairy products for example would benefit from having an overview of the location of items and objects in the distribution network, such as the whereabouts of a large number of trays of milk. A system where location information and time information associated to items is collected would generate valuable information on the status and behavior of the distribution network. Such information could be beneficial for the supplier in order to have documented the location of a carrier/container because it contains something which is important to know location of or because the carrier/container itself has value in it. It could also be beneficial to know the location of an item or carrier/container in order to collect information for decision making such as for stock management, production management and distribution performance management for example. In order to provide such logistic monitoring in a semi-automatic manner previous systems have required manual inputs and/or RFIDs. Furthermore attempts to doing so in a complete automatic manner have either required installation of expensive infrastructure for each location or semi-automatic method to identify individual items or a small group of items which are being left at a location (US 2007/0282482).

US 2009/0037244 discloses a prior art system which is an inventory management system for identifying and locating items in a facility. This system uses a plurality of ID tags, each of which includes identification information regarding an item to which each respective identification tag is attached. The system also uses a memory device to hold information on all the items in the facility, as well as an input device operable to receive information from a user and a plurality of readers positioned around the facility, where each reader is operable to transmit an inquiry signal to trigger one or more identification tag to emit a response signal received by at least one reader of the plurality of readers. A controller is connected to the readers and the input device to control the readers to emit the inquiry signal and to provide location information indicating a location of the desired item requested by the user based on the response signal. Furthermore, the controller retrieves image information for the desired item from the memory device and the location information and image information related to the desired item is displayed to the user of the system. The prior art technology requires a large and expensive network structure for larger distribution networks, where each destination location requires a device for receiving items and to determine a present location or delivery of an item.

### SUMMARY OF THE INVENTION

The system and the method of the present invention provides a solution to the above mentioned problem and allows for distribution monitoring of shipments and automatic location assignment using virtual location information and wireless technology. The system of the present invention provides a technology to register previous and present locations in a distribution system with a larger amount of items in an automatic manner and with more precision than prior systems. This is obtained by using data sent from wireless sensory loggers or wireless ID tag when in the proximity of a transceiver and use information stored in a centralized database system to assign the wireless sensor and associated object (container/carrier, transport box etc) to a location in a distribution network, where a method is used in the transceiver to estimate in an efficient way whether an ID tag has been left at a location or picked up from a location. The present invention discloses long-life wireless loggers/IDs installed in all objects/items, which are of interest, where full functionality can be gained with a minimum infrastructure, where transceivers are only needed in transportation vehicles.

The present solution differs from prior art solutions in that a minimum infrastructure logistics solution is provided which is fully automatic. Prior solutions are not able to monitor large number of items with as little infrastructure as the system and method of the present invention in an automatic manner. The transceivers provided update location information automatically and assign locations to items automatically, where no manual input is required.

The communication between transceivers and sensors is wireless and the wireless range is larger than for other prior art solutions which use e.g. RFID.

The solution provided by the present invention uses combination of the location information, which is stored in the centralized database system, real-time information on objects, containing a wireless sensor/ID at the vicinity of a transceiver and geometrical coordinates, giving the system a way of assigning location to an object or a carrier/product container. As an example a dairy distribution system using trays on wheels to carry the dairy products, where the trays are used to both transport the dairy products in transport trucks and store the products in at production site and in stores. The transceiver unit is positioned in the transport truck and the sensor/ID associated with each tray reports continuously or discontinuously its presence to the transceiver unit as long as the sensor/ID is in the vicinity of the transceiver unit. In this manner the central database knows, from location events and information sent form transceivers and sensors, if a tray is left at a certain store as it stops reporting after the transport truck leaves the store, as the transceiver unit is positioned in the transport truck. When the transport truck leaves the location an event is issued, defining which trays were left behind at the location and which trays were loaded onto the truck or remained in the truck. No reading is required, either automatic or manual, in this fully automated system.

The present invention provides a system to automatically assign items to a location of some meaning in a distribution network, requiring only one or more transceivers in each transport vessel. The system uses wireless active ID tags, a transceiver or a network of transceivers and a centralized database for obtaining this goal. The wireless active ID tags comprise a memory, a processor and a wireless communication module, where one or more wireless active ID tags can be assigned to an item of importance. The wireless active ID tag can communicate through a transceiver by using a wireless communication protocol and it is capable of storing last location information in its memory. Furthermore, the wireless active ID tag is capable of updating its last location once it enters a new location other than its last location. Each transceiver comprises a memory, a processor, a wireless communication module and a network connection. The transceiver is configured to be at a location (knows its location), either a stationary location or a transport location, and it can issue events to the centralized database indicating that a certain item, containing one or more wireless active ID tags, has entered a location by comparing the last location of the wireless ID to the location which the transceiver has been configured to. The transceiver is present in each transport vessel and is able to fetch information on locations from the centralized database and change its location ID depending on geographical information fetched from the centralized system. The centralized database stores information on location including, but not limited to, geographical position for each the location and a list of transceivers set to the location. The centralized database then stores information on items including, but not limited to, a list of wireless active ID tags associated to the item, and boundaries if a sensor is attached to a wireless active ID tag. Each transceiver communicates with one or more wireless active ID tag where automatic communication of data between wireless active ID tags, transceivers and centralized database is performed by a communication protocol. Assigning an item onto a location is performed by a transceiver by comparing its current location ID to the last location of the wireless ID and issuing an event to the centralized database and updating the last location of the wireless active ID tag to the current location of the transceiver if the they do not match and the transport vessel has traveled for a specific distance and internal processes in the transceiver have estimated which items were left on the last location and which items were picked up.

In a first aspect of the present invention a system to automatically assign items to a location of some meaning in a distribution network is provided, The system comprises wireless active ID tag(s) assigned to an item(s) in the distribution network, where the wireless active ID tags comprises at least a memory, a processor and a wireless communication module, where the wireless active ID tags store a last location information in its memory and updates the last location once it enters a new location other than its last location. The system further comprises one or more transport vessels equipped with one or many transceivers, where each transceiver is assigned to a location and the transceiver comprises at least a memory, a processor, a wireless communication module and a network connection. Furthermore, the system comprises a centralized database to store information relating to the items and the wireless active ID tags associated to the items, to store location definitions and transceivers associated to said locations and to receive and store location information data from transceivers. The system is characterised in that each transceiver communicates with one or more wireless active ID tags and in that automatic communication of data between wireless active ID tags, transceivers and centralized database is performed by a wireless communication protocol. The system is further characterised in that assigning an item to a location is performed by updating the location of all wireless active ID tags at a new location in the transceiver in the transport vessel, updating the presence of all wireless active ID tags at in the transport vessel after leaving the location, and issuing an event indicating which items were loaded off at the last location, which items were loaded on at the last location and which items remained in the transport vessel after the last location.

In a second aspect of the present invention a method to automatically assign items to a location of some meaning in a distribution network is provided. The method comprises providing wireless active ID tag(s) assigned to an item(s) in the distribution network, where the wireless active ID tags comprises at least a memory, a processor and a wireless communication module, where the wireless active ID tags store a last location information in its memory and updates the last location once it enters a new location other than its last location. The method further comprises providing a network of transceivers, where each transceiver is assigned to a location and the transceiver comprises at least a memory, a processor, a wireless communication module and a network connection. Furthermore, the method comprises providing a centralized database to store information relating to the items and the wireless IDs associated to the items, to store location definitions and transceivers associated to said locations and to receive and store location information data from transceivers. The method is characterised in that each transceiver communicates with one or more wireless active ID tags and in that automatic communication of data between wireless active ID tags, transceivers and centralized database is performed by a wireless communication protocol. The method is further characterised in that assigning an item to a location is performed by the transceiver by updating the location of all wireless active ID tags at a new location in the transceiver in the transport vessel, updating the presence of all wireless active ID tags at in the transport vessel after leaving the location, and issuing an event indicating which items were loaded off at the last location, which items were loaded on at the last location and which items remained in the transport vessel after the last location.

### DETAILED DESCRIPTION OF PREFERRED EMBODIMENTS

The following definitions and embodiments relate to the method and the system of the present invention.

In an embodiment of the present invention multiple locations, located at the same coordinates, are grouped together as a single destination location.

In another embodiment of the present invention the transceiver in the transport vessel identifies all wireless active ID tags at a new location inside as well as outside the transport vessel.

In an embodiment of the present invention the transceiver unit uses geographic positioning information to determine that the transport vessel has left the last location and to issue an event indicating which items were loaded off at the last location. The geographic positioning information determines that the transport vessel has left the last location after the transport vessel has traveled a predetermined distance from the last location.

In an embodiment of the present invention the transceiver unit uses a pre-determined time period to determine that the transport vessel has left the last location and to issue an event indicating which items were loaded off at the last location.

In an embodiment of the present invention the transceiver obtains information using geographical information associated with a location from the centralized database. Furthermore, the transceiver can collect information on multiple locations in a region where the transceiver is located and store the collected information in memory to reduce the load on the centralized database. This allows the transceiver to store location information in its memory,

so that it does no need to fetch repeatedly for a certain region, thus, reducing the load on the centralized database system and improving redundancy in the system in case of a network connection failure.

In an embodiment of the present invention the transceiver stores events which should be sent to the database system in memory in the event that the transceiver cannot communicate with the centralized database system (i.e. due to cellular or internet network failure), and sends the information when it can communicate again with the centralized database.

In an embodiment of the present invention the transceiver learns which locations it uses frequently in the event that the transceiver is unable to connect the centralized database. This will minimize latency, data transmission, load on centralized system and create redundancy. In a distribution network where multiple locations are to be found and/or transportation routes cover a large area, the number of locations can grow quickly. When using communication means where data transmission is charged by the quantity and increased load on database is a concern, it is important to limit the data transmissions and frequency of access to the database. The transceiver can therefore learn which locations it uses frequently. If the transportation route does not vary between transportations or the set of destinations is limited, the transceiver can learn all its locations of importance. That causes the transceiver to require fewer access to the centralized database, thus reducing data communication cost and reduce load on the centralized database. This, in turn, creates an important redundancy in the system where the transceiver can lose connection with the centralized database system but still being able to issue location events for items being transported, given that the transceiver, the wireless active ID tags and geographical positioning is operating normally.

In an embodiment of the present invention the transceiver assigns a location, predefined in the centralized database, to itself by updating its current location using geographic positioning information which matches the predefined location information in the centralized database.

In an embodiment of the present invention the transceiver issues an event, indicating that an item has arrived to a location, by comparing its current location to the last location, stored in the sensor. If the information does not match, an event is issued.

In an embodiment of the present invention when the transceiver is located in the vehicle, the transceiver only assigns a location to the item with an event if the transceiver detects that the item was left at the last location, by using a configurable time delay and other methods. The transceiver thus does not assign items to locations it visits unless the items are left behind.

In an embodiment of the present invention the unique id of each transceiver determines a physical location information of the transport vehicle in a centralized database and updates geographical location through a geographical coordinate. Furthermore, the geographical location of each transceiver unit is determined by a geographical coordinate in the centralized database.

In an embodiment of the present invention the transceivers are aware of other locations in its vicinity and base the decision whether or not to issue events on that awareness.

In an embodiment of the present invention the transceiver indicates automatically if a sensor is connecting to a new destination location and issues events to the centralized database to inform it that the sensor has changed destination location. In such an embodiment the event contains more than one destination location ID, indicating that multiple locations might be relevant as the destination location where each location sent with the event is ranked. Also, in such an embodiment the centralized database uses additional information on locations, stored in the centralized database, to estimate the likeliest destination location from the list of locations sent with the event.

In an embodiment of the present invention the location is gained by fetching location information from the database or from transceiver memory for location at a certain geographical location.

In an embodiment of the present invention the wireless active ID tag contains a sensor to obtain measurements, accumulate the measurements into memory and transmit them to a centralized database.

In an embodiment of the present invention the transceiver automatically requests location information from the database where the transceiver stores and manages location definitions and stores in transceiver memory. The transceiver retrieves a list of locations from the database, which means that it is not required to request a location from the database each time it is needed. Instead a list of locations is collected and the it learns gradually what locations should be stored and which not.

In an embodiment of the present invention the location information contains information on the role of the location in the distribution network.

In an embodiment of the present invention the item information in the centralized database contains, reference to the item or product being transported, the content of the item, the value of the content and lifetime of the content.

In an embodiment of the present invention the transceiver indicates automatically if a sensor is connecting to a new destination location and issues events to the centralized database to inform it that the sensor has changed location or has been assigned to a new location in the distribution system.

The transceiver of the present invention has a unique ID which identifies it from other transceivers, where the unique id serves a purpose to distinguish between transceivers both in terms of a physical location and in a centralized database system. Each transceiver is linked to a location, where the location may have a unique id which is registered in the centralized system. If one destination location is very close to another destination location the real position of the shipment is calculated from probability based on the vicinity of the sensor to the shipment. The transceivers communicate wirelessly with sensors and deliver logged measurements and events to a centralized database.

Sensor/ID of the present invention reports its presence once he is in the vicinity of a transceiver, in addition to that the sensor/ID stores its last location ID and therefore the transceiver will detect if the sensor/ID is shifting locations. If the sensor is switching locations, an event indicating that the sensor was entering a new location is generated. Sensors can deliver logged measurements to the centralized online database through the transceiver, when the transceiver is in range for wireless communication.

Long-life wireless loggers/IDs are small unit which notifies a transceiver of its presence once in wireless connection with the transceiver. The wireless ID stores information on its last location. The wireless IDs operate on batteries for many years.

In the present context the term “transceiver unit” refers to a transceiver module which is positioned at the destination location and/or in the transport vehicle used to ship the items to be monitored. The transceiver unit has a unique ID which identifies it from other transceivers, where the unique ID serves a purpose to distinguish between transceivers both on a physical location and in a centralized database system. The transceiver unit is also a device which communicates with sensors in a wireless manner and delivers logged measurements to a database. The Transceiver can receive real-time data, accumulated measurement logs, settings, events and configuration from a sensor, process the information, buffer it, and transmit it to the centralized system via an network connection (GPRS, Wi-Fi, LAN, Ethernet or other network connection). Furthermore, the transceiver can transmit configuration parameters and/or commands to all sensors on a network or a specific sensor. The configuration can either have origin in the centralized system, generated by the user or the system, or automatically in the transceiver for management purposes. Wireless data-loggers, as defined herein, can be implemented into the transceiver. Transceivers indicate, in an automatic manner, if wireless data-loggers connect to a new location events are issued to the centralized system to inform it that that specific sensor had changed location.

In the present context the term “wireless data-logger” and “wireless sensory logger” refers to devices having a sensor to measure environmental conditions which are of relevance to the user and/or the system. The sensor logs measurements into memory, communicates and transmits logged measurements to a centralized online database through a transceiver, once he is in range for wireless communication. The sensor has all the features necessary for location assignment and are a part of the wireless active ID tag.

In the present context the terms “wireless active ID tag” and “wireless ID” refer to a device which does not necessarily have a sensor, but can notify a transceiver of its presence with wireless communication. The wireless ID knows which location was his last and notifies the transceiver of that. The transceiver bases his decision, whether to issue a location event or not, on that information.

In the present context the term “item” refers to a physical object, a product or other thing which may be of value to someone to know the current whereabouts and where the item has been in the past, for purposes such as checking balances, usage of items, analysis etc. An item may be, including but not limited to, food container, waist product container, medicine package, container, equipment and livestock.

In the present context the term “location” refers to a physical locations which is of importance in the distribution chain and can either refer to a stationary location (i.e. factory, production plant, customer, storage facility) or a movable location or transport vessel (i.e. transportation truck, train, boat etc.) and have location data based thereon. The location data can contain references to up to a number of transceiver. Destination location refers to a location where an item is left after transport. Transport location and transit refer to a location which items are placed during transportation between stationary or transport locations.

In embodiments of the present invention location data may be collected through a network for geographical positioning, e.g. GPS or mobile phone network. Therefore locations for the route of the shipment can be recorded.

In the present context the term “destination” or “destination location” is a physical locations which has a definition for its location assigned to in the centralized database.

Information in location definitions, which are stored in the centralized database, includes but is not limited to the following: unique ID, reference ID, name, address, description, coordinates (GPS or similar), radius, owner etc.

All the above is gained in an automatic manner with the proposed method. To gain similar functionality, the user has been required to do this manually or by using RFIDs.

### DETAILED DESCRIPTION OF PREFERRED EMBODIMENTS

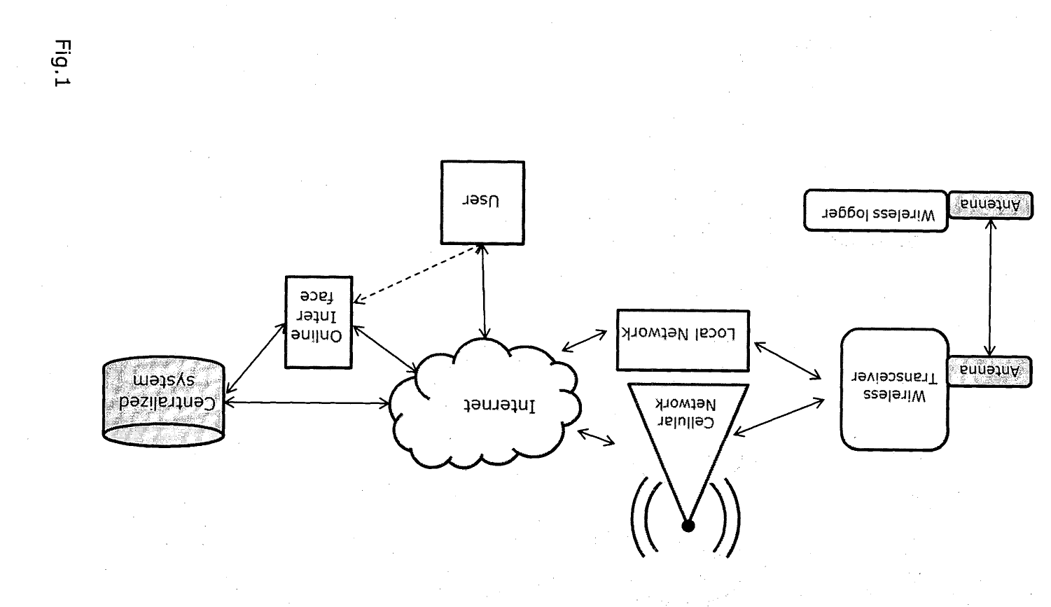

FIG. 1 shows an overview of the system of the invention.

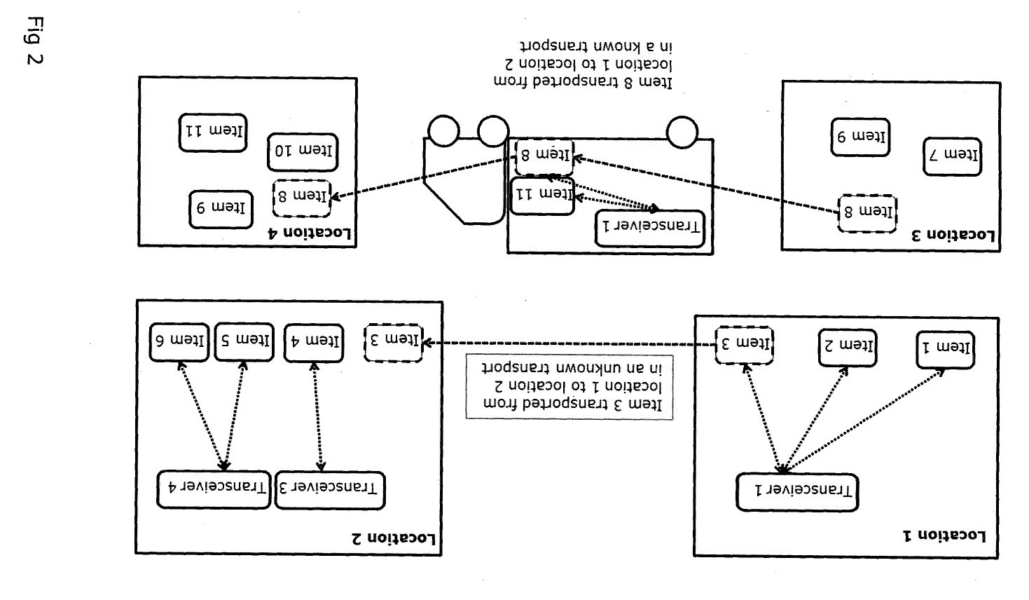

FIG. 2 discloses embodiments of the system and method of the present invention.

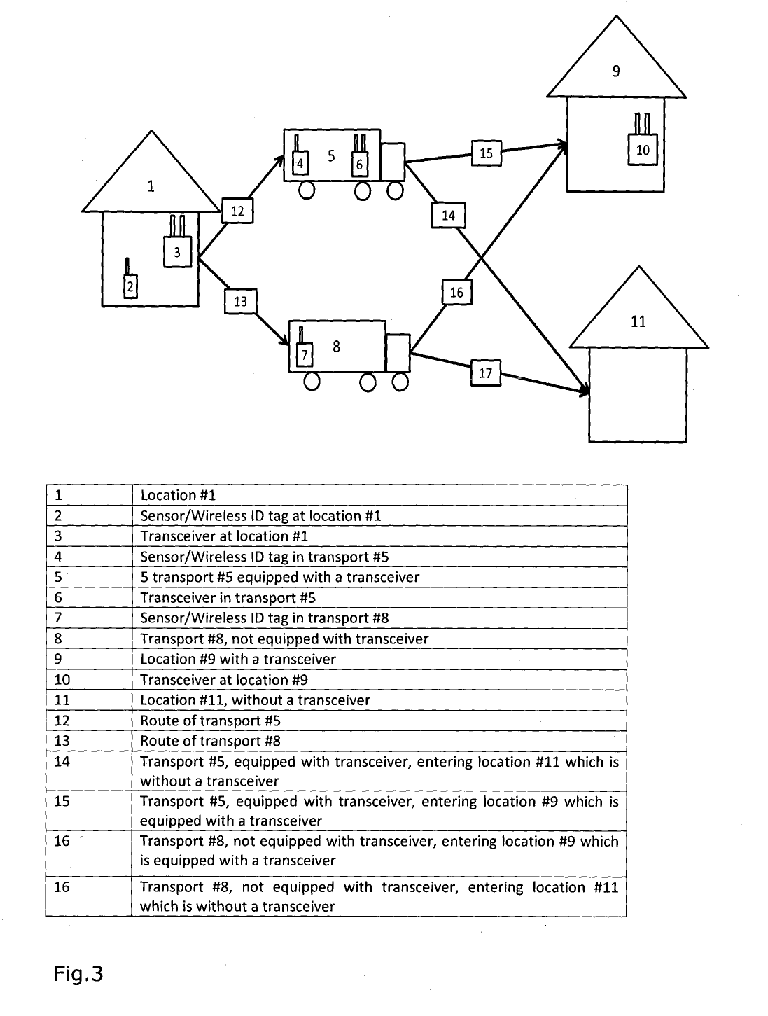

FIG. 3 shows different scenarios possible in a distribution chain as described in example 2.

FIG. 1 shows how a wireless data-logger communicates real time status of a location of an item to a transceiver while wireless data-logger is within reach of a transceiver for wireless communication. The transceiver communicates wirelessly with wireless data-loggers and can receive real-time data, accumulated measurement logs, locations, settings, events and configuration from a wireless data-logger, process the information, store it in memory, and transmit the data to the centralized system via a network connection (GPRS, Wi-Fi, LAN, USB, Ethernet or other network connection). The centralized system can send configuration parameters, commands, software updates, locations and other information to a transceiver. Data, measurements, events and other information, is stored in a database upon reception by the centralized system. The data can be accessed by users through an online interface. Analysis can be performed on the data by the centralized system.

FIG. 2 show embodiments of the system and method of the present invention, where each location is defined in the centralized system with information such as location name, address, type and GPS coordinates. The location definition also contains a list of transceivers on that location, if there are any.

### Example 1

As the transceiver is located in the transport vessel, there is no need for a transceiver at the location to issue location events. This setup is practical for many types of businesses since the investment in infrastructure is minimal, since transceivers are not necessary at locations in the distribution network.

When an item with an associated wireless ID enters a location in a transportation vessel with an associated transceiver, the transceiver issues a location event once it notices that the item with an associated wireless ID has been left behind. If the item was not left behind, no event is sent to the centralized system.

### Example 2

In FIG. 3, different scenarios possible in a distribution chain, in terms of infrastructure and functionality depending on it are shown.

### Item Picked Up

According to the present invention a transceiver (6) in transport vessel (5) picks up one or more items which are equipped with a wireless ID tag (4). When item is moved from location 1, which may or may not be equipped with a transceiver, into the transport vessel (5) the ID tag starts to communicate with the transceiver (6) in the transport vessel. The ID tag will communicate its last location to the transceiver. If the last location does not match the location ID of the transceiver in the transport vessel the transceiver will register the ID tag as a new item on the transport vessels location. However, the transceiver will not issue a location event to the centralized system until the transport vessel has moved a certain distance from the location, and it is considered to have left the location. This is done by using global positioning coordinates which the transceiver acquires by using GPS, for example. If the item continues to communicate with the transceiver in the vehicle for defined distance, the transceiver will issue an event to the centralized system indicating that the item is now on the transport vessel location and it will update the current location information, stored in the wireless ID tag, to the location ID of the transport vessel. By doing this, the item is only moved from location 1 if and only if the item continues to communicate with the transceiver in the transportation vessel (5). This is an important feature of the invention to ensure that items that are in the vicinity of the transport vessels are not moved from location 1 when a transceiver in a transport vessel starts to communicate with surrounding items which do not enter the transport vessel.

### Delivery of an Item to a Location

When transport vessel 5 stops at location which may or may not contain a transceiver (9 or 10), it will, based on its current position coordinates, scan its memory for known locations at this coordinates or request the centralized system for location information for locations in the region. If the transceiver finds a match for the location it will be temporarily rendered as a benign currently a part of that location. It will update the current location of the ID tags, known to be in the transport vessel, to the new current location.

The transceiver has all items on its location registered in memory and, thus, knows which items have been registered on the transceivers location. The transceiver will not issue events for the items until it leaves the location and has traveled a defined distance from the location and notices that a wireless ID task is no longer transmitting information to the transceiver. Then, and only then, will the transceiver have a confirmation that an item was left at the last location and will issue an event to the centralized system to indicate that. It will then update the current location of the ID tags in the transport vessel to the original location ID—the transit location assigned to the transport vessel. This will ensure that events are not issued to a location for items that are in the transport vessel before and after it stops at a location.

### Example 3

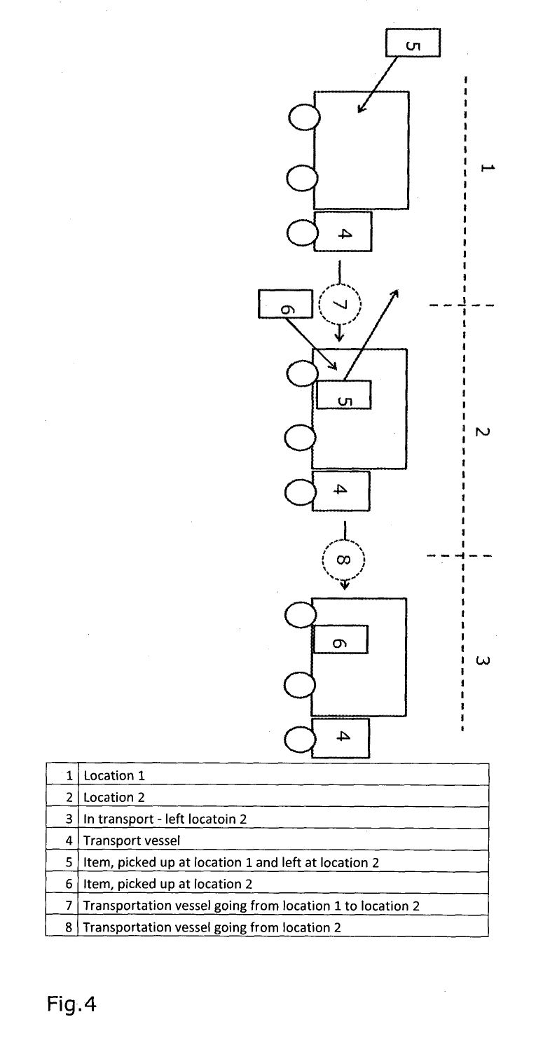

The system of the present invention assigns items to a location by issuing events to a centralized database system based on which wireless ID tags are detected and expected to have either left or entered a transit location. FIG. 4 shows the process of estimating if an item has entered or left a transit location is done in the transceiver associated with the transit location in the following way:
During transportation the transport vessel is moving. While it is doing that, it is capable of requesting location information from the centralized system.
During transportation the transceiver keeps track of which ID tags are reporting to the transceiver. Those items are then currently on the transit location associated with the transceiver.
When transport vessel stops at some geographical location for a certain time period. The transceiver, based on its current geographical location, checks in its memory or by doing a request to the centralized system.
If the transceiver detects that there is a location at, or near, the current geographical location, it will be rendered as a benign currently a part of that location and update all the sensors currently connected to the transceiver with new location ID information.
During operation the transceiver keeps track of which items are sending data through it.
Once the transceiver leaves the location and has traveled a certain distance, the transceiver will, based on its item list, issue events:
indicating a delivered item to the last location if items are no longer sending data through the transceiver
indicating an item which has been picked up at the last location if the transceiver detects that new wireless tags are sending which have not previously been sending data.

1. A system to automatically assign items to a location of some meaning in a distribution network, comprising of:
a. wireless active ID tags assigned to an item(s) in the distribution network, said wireless active ID tags comprising:
a memory
a processor
a wireless communication module
wherein the wireless active ID tags store a last location information in its memory and updates the last location once it enters a new location other than its last location,
b. one or more transport vessels, equipped with one or many transceivers, wherein each transceiver is assigned to a location and said transceiver comprising:
a memory
a processor
a wireless communication module
c. a network connection to a centralized database to
store information relating to the items and the wireless IDs associated to the items
store location definitions and transceivers associated to said locations,
receive and store location information data from transceivers,
wherein each transceiver communicates with one or more wireless active ID tags and where automatic communication of data between wireless active ID tags, transceivers and centralized database is performed by a wireless communication protocol, and
wherein assigning an item to a location is performed by
i. updating the location of all wireless active ID tags at a new location in the transceiver in the transport vessel,
ii. updating the presence of all wireless active ID tags at in the transport vessel after leaving the location, and
iii. issuing an event indicating which items were loaded off at the last location and which items were loaded on at the last location.

2. The system according to claim 1, wherein the transceiver in the transport vessel identifies all wireless active ID tags at a new location inside and outside the transport vessel.

3. The system according to claims 1 and 2, wherein the transceiver unit uses geographic positioning information to determine that the transport vessel has left the last location and to issue an event indicating which items were loaded off at the last location and which items were loaded on at the last location.

4. The system according to claim 1-3, wherein the transceiver unit uses a pre-determined time period to determine that the transport vessel has left the last location and to issue an event indicating which items were loaded off at the last location.

5. The system according to claims 1-4, wherein the transceiver obtains information using geographical information associated with a location from the centralized database.

6. The system according to claim 5, wherein the transceiver collects information on multiple locations in a region where the transceiver is located and stores the collected information in memory to reduce the load on the centralized database.

7. The system according to claim 5, wherein the transceiver learns which locations it uses frequently in the event that the transceiver is unable to connect the centralized database.

8. The system according to any of the preceding claims, wherein the unique id of each transceiver determines physical location information of a destination location in a centralized database.

9. The system according to any of the preceding claims, wherein the geographical location of each transceiver unit is determined by a geographical coordinate in the centralized database.

10. The system according to any of the preceding claims, wherein multiple locations, located at the same coordinates, are grouped together as a single destination location.

11. A system according to claim 9, wherein transceivers are aware of other locations in its vicinity and base the decision whether or not to issue events on that awareness.

12. The system according to any of the preceding claims, wherein the event contains more than one destination location ID, indicating that multiple locations might be relevant as the destination location where each location sent with the event is ranked.

13. The system according to claim 12, wherein the centralized database uses additional information on locations, stored in the centralized database, to estimate the likeliest destination location from the list of locations sent with the event.

14. The system according to any of the preceding claims, wherein the wireless active ID tag contains a sensor to obtain measurements, accumulate the measurements into memory and transmit them to a centralized database.

15. The system according to any of the preceding claims, wherein the location information contains information on the role of the location in the distribution network.

16. The system according to any of the preceding claims, wherein the item information in the centralized database contains;
reference to the item or product being transported
the content of the item
the value of the content
lifetime of the content
